(19) United States
(12) Patent Application Publication
(10) Pub. No.: US 2026/0225301 A1
(43) Pub. Date: Aug. 6, 2026

(54) DROPPER CONTAINER, A USE OF A POLYMERIC MATERIAL FOR MAKING A DROPPER CONTAINER, AND A METHOD FOR MAKING A DROPPER CONTAINER

(71) Applicant: SACMI COOPERATIVA MECCANICI IMOLA SOCIETA' COOPERATIVA, IMOLA (BOLOGNA) (IT)

(72) Inventors: ALESSANDRO FALZONI, IMOLA (BOLOGNA) (IT); NICCOLÒ GIANI, IMOLA (BOLOGNA) (IT)

(21) Appl. No.: 19/044,754

(22) Filed: Feb. 4, 2025

(51) Int. Cl. B29C 49/00; B01L 3/02

(52) U.S. Cl. CPC B29C 49/071; B01L 3/0272; B29C 2949/0715

(57) ABSTRACT

A dropper container made by compression molding of a dose of molten polymeric material to obtain a preform and by successive blow molding of the preform, wherein the dropper container includes a body, the body being squeezable to dispense liquid contained therein and extending around a longitudinal axis between a first end and a second end, and a nozzle, connected to the body at the first end and configured for releasing liquid as droplets, responsive to a pressure of the liquid contained in the body, and wherein the polymeric material is a blend of LDPE and MDPE, the LDPE being at least 20% of the total weight of the polymeric material.

### FIELD OF THE INVENTION

This invention relates to a dropper container, a use of a polymeric material for making a dropper container and a method for making a dropper container.

In particular, the invention relates to dropper container made by compression molding of a dose of molten polymeric material to obtain a preform and by successive blow molding of the preform.

### BACKGROUND OF THE INVENTION

Generally, the dropper container includes a body and a nozzle. The body is used to contain a liquid and it is squeezable to dispense the liquid through the nozzle, which releases the liquid as droplets.

Dropper containers (or squeezable bottles) are mostly used for the application of ophthalmic solutions. In this application, the container is not limited to only store the drug product, but it is an integral part of the function of the entire eye dropper system. Therefore, the design of the bottle is a crucial point for the functionality of the eye dropper system.

The neck features which seal the bottle content through the eye dropper must fulfil very tight tolerances in order to protect the content from the environment and avoid possible contamination of the drug. Moreover, the right squeezable behaviour for precise drug release through the eye dropper system is assured by the proper mechanical properties of the container that are strictly dependent to the thickness distribution of the bottle and the material stiffness.

The LDPE is the conventional resin used for squeezable bottle thanks to its excellent softness (e.g. flexural modulus below 350 MPa) and the wide elastic range which assure the easy and stable squeezable behaviour.

Differently, HDPE and MDPE resins are characterized by higher stiffness, with a flexural modulus of 750-1500 MPa for HDPE and 400-800 MPa for MDPE, and by a lower elastic range compared to the LDPE. Therefore, the neat HDPE and MDPE are not suitable resins for a conventional squeezable bottle.

### BRIEF SUMMARY OF THE INVENTION

Scope of the present invention is to overcome at least one of the aforementioned drawbacks. In particular, an aim of the present invention is to provide a dropper container that combines excellent elastic behavior, making it suitable for squeezable applications, with strong mechanical properties that ensure the stiffness of a lightened bottles.

This scope is achieved by the dropper container, the use of a polymeric material for making a dropper container and a method for making a dropper container, according to the appended claims.

In particular, the dropper container is made by compression molding of a dose of molten polymeric material to obtain a preform and by successive blow molding of the preform. The dropper container can be made by Compression Blow Forming (CBF), as described in U.S. Pat. Nos. 7,658,882B2, 8,308,473B2 and 8,366,436B2, by the same Applicant, or by Linear Blow Forming (LBF) technology, as described in IT202100032507, IT102022000011978 and IT102022000011984 by the same applicant.

The dropper container includes a body. The body is squeezable to dispense liquid contained therein. The body extends around a longitudinal axis between a first end and a second end. The dropper container includes a nozzle. The nozzle is connected to the body at the first end. The nozzle is configured for releasing liquid as droplets, responsive to a pressure of the liquid contained in the body. The nozzle may have an opening for releasing the liquid. The dropper container may comprise a neck; the neck is connected to the first end of the body so that the nozzle is connected to the first end of the body through the neck. The nozzle may be integral with the body (or with the neck) or separable with respect to the body (or with the neck). The nozzle may be connected or attached to the body of the container (in particular, to the neck), for example by snapping it onto the container, according to the snap-on neck type of dropper containers.

In particular, the polymeric material is a blend of LDPE and MDPE. In an example, the LDPE is at least 20% of the total weight of the polymeric material. The MDPE is used combined with LDPE to obtain a lightened container. The LDPE fraction can ensure the elastic behavior suitable for the squeezable application. On the other hand, the MDPE fraction proves the mechanical properties useful to guarantee the stiffness of a lightened bottle. The combination of MDPE and LDPE resins allow the lightening by 25% of the dropper container without losing the squeezable performance. This aspect has positive effects both from the environmental point of view and also an economic impact for the packaging manufacturers.

In an example, the LDPE is at least 50% of the total weight of the polymeric material.

Preferably, the LDPE is lower than 85% of the total weight of the polymeric material. More preferably, the LDPE is lower than 60% of the total weight of the polymeric material.

In an example, the body has a wall having an average thickness comprised between 0.5 mm and 0.85 mm. In particular, the body has a wall having an average thickness comprised between 0.7 mm and 0.8 mm. For a capacity of 5 mL of the dropper container, a weight of the body without the liquid may be lower than 1.5 g. In particular, for a capacity of the dropper container between 5 mL and 15 mL, a ratio between a volumetric capacity and a weight of the body may be higher than 3.0 mL/g. In an example, the die swell of the polymeric material is higher than 1.5, preferably higher than 1.6, more preferably higher than 1.8.

This disclosure also provides a use of a polymeric material for making a dropper container. The dropper container may be made according to any feature of the present disclosure. In particular, the dropper container is made by compression molding of a dose of molten polymeric material to obtain a preform and by successive blow molding of the preform; the dropper container includes a body, squeezable to dispense liquid contained therein and extending around a longitudinal axis between a first end and a second end, and a nozzle, connected to the body at the first end and configured for releasing liquid as droplets, responsive to a pressure of the liquid contained in the body. In particular, the polymeric material is a blend of LDPE and MDPE. In an example, the LDPE is at least 20% of the total weight of the polymeric material. In an example, the LDPE is at least 50% of the total weight of the polymeric material.

The LDPE may be lower than 85% of the total weight of the polymeric material; in particular, the LDPE may be lower than 60% of the total weight of the polymeric material. In an example, the die swell of the polymeric material is higher than 1.5, preferably higher than 1.6, more preferably higher than 1.8.

This disclosure also provides a method for making a dropper container. The dropper container may be made according to any feature of the present disclosure. In particular, the dropper container is made by compression molding of a dose of molten polymeric material to obtain a preform and by successive blow molding of the preform; the dropper container includes a body, squeezable to dispense liquid contained therein and extending around a longitudinal axis between a first end and a second end, and a nozzle, connected to the body at the first end and configured for releasing liquid as droplets, responsive to a pressure of the liquid contained in the body.

The method comprises a step of compression molding of a dose of molten polymeric material to obtain a preform. The method comprises a step of blow molding of the preform to obtain the dropper container. In an example, the polymeric material is a blend of LDPE and MDPE. In an example, the LDPE is at least 20% of the total weight of the polymeric material. In an example, the LDPE is at least 50% of the total weight of the polymeric material.

The LDPE may be lower than 85% of the total weight of the polymeric material; in particular, the LDPE may be lower than 60% of the total weight of the polymeric material.

In an example, the body has a wall having an average thickness comprised between 0.5 mm and 0.85 mm. For a dropper container of 5 mL, a weight of the body without the liquid may be lower than 1.5 g.

The die swell of the polymeric material is higher than 1.5, preferably higher than 1.6, more preferably higher than 1.8.

### BRIEF DESCRIPTION OF THE DRAWINGS

This and other features of the invention will become more apparent from the following detailed description of a preferred, non-limiting example embodiment of it, with reference to the accompanying drawings, in which:

FIG. 1 illustrates a dropper container according to one or more aspects of the present invention;

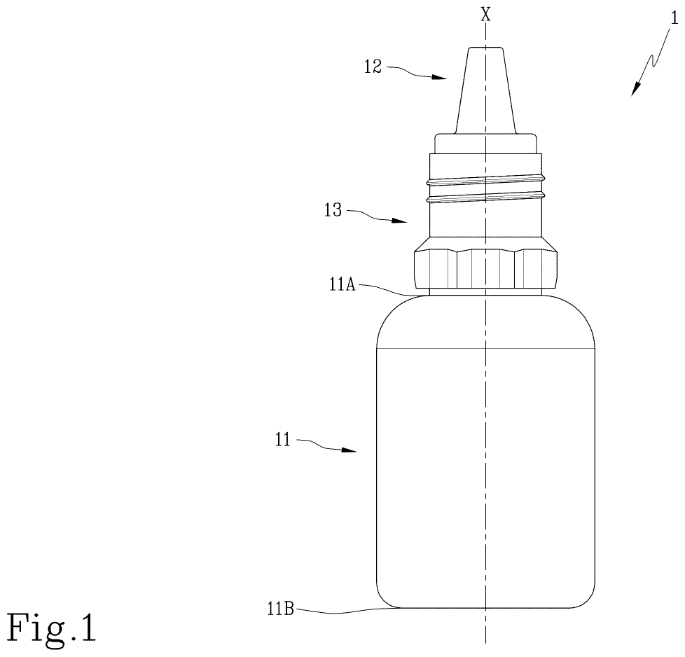

FIG. 2 illustrates the wall thickness distribution of a 5 cc bottle made of LDPE and MDPE/LDPE blend;

FIG. 3 illustrates the stress/strain graph of compression test of bottles.

### DESCRIPTION OF EXAMPLE EMBODIMENTS

With reference to the accompanying drawings, the numeral 1 denotes a dropper container. The dropper container 1 includes a body 11. The body 11 is configured for containing liquid, preferably an ophthalmic solution. The body 11 is squeezable to dispense the liquid contained therein. The body 11 extends along a longitudinal axis X, between a first end 11A and a second end 11B. The dropper container includes a nozzle 12, connected to the body 11 at the first end 11A. The nozzle 12 is connected to the body 11 by a neck 13. The neck 13 has a thread. The thread is configured to be coupled with a corresponding thread of a closure. The nozzle 12 is configured for releasing liquid as droplets, responsive to a pressure of the liquid contained in the body 11, for example through an aperture provided at the nozzle 12.

A 5 mL dropper container with a 15 mm snap-on neck has been used to study the MDPE/LDPE blends in order to simulate the mechanical behavior of the same bottle with higher weight and thickness made of LDPE. 2 different kinds of blends have been tried: the LDPE-poor blends and the LDPE-rich blend. The first type includes a LDPE content from 10% to 40%, preferably the blend MDPE/LDPE 80/20. The LDPE-rich blend ranges from LDPE content of 45% to 70%, more preferably the blend MDPE/LDPE 50/50. The main mechanical properties of interest are the elastic modulus and the compression force required to squeeze the bottle.

The material used:
the DOW™ MDPE DNDA-1796 NT 7 has been gently supplied by Dow Chemical Company; it is characterized by a density of 0.939 g/cm³ and a flexural modulus of 655 MPa;
the DOW™ 20-6064 HEALTH+™ has been gently supplied by Dow Chemical Company; it is characterized by a density of 0.92 g/cm³.

The side load test is used to determine the squeezability performance. The characterization was done using an Instron machine 3360 series with a load cell of 100 N. The test was conducted in compression mode with a deformation of 3 mm at 10 mm/min.

The thickness distribution is assessed by the MagnaMike instrument using the 1/16″ ball.

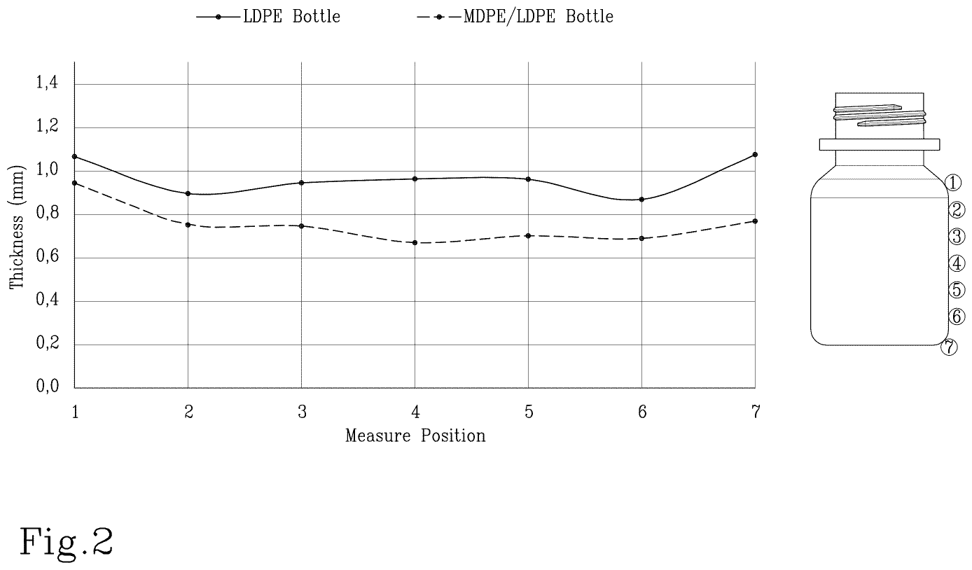

The bottle object of this study has a nominal volume of 5 ml with a 15 mm snap-on neck. The conventional LDPE bottle has the weight of 2.5 g, and the average thickness of the panel is 0.92 mm. The same bottle geometry is used for the MDPE/LDPE version but exploiting the unique preforming phase of the compression technology the preforming tools have been modified to reduce the preform wall thickness and, consequently, the bottle weight by 25%. In fact, the average wall thickness of the MDPE/LDPE bottle decreases from 0.92 mm to 0.75 mm (as shown in FIG. 2).

The squeezability performance has been evaluated considering the elastic modulus and compression load of samples. The elastic modulus is calculated considering the initial linear part of stress/strain curves from 0.1 mm to 0.5 mm. The results are reported in the following table, which shows a comparison of mechanical properties of neat LDPE and MDPE/LDPE blends.

| | | Elastic Modulus | Compression |
|---|---|---|---|
| Material | Weight (g) | (MPa) | Load (N) |
| LDPE | 2.5 | 128 ± 4 | 22.1 ± 1.7 |
| MDPE/LDPE | 1.9 | 163 ± 3 | 26.8 ± 2.1 |
| 80/20 | | | |
| MDPE/LDPE | 1.9 | 120 ± 5 | 19.9 ± 1.5 |
| 50/50 | | | |

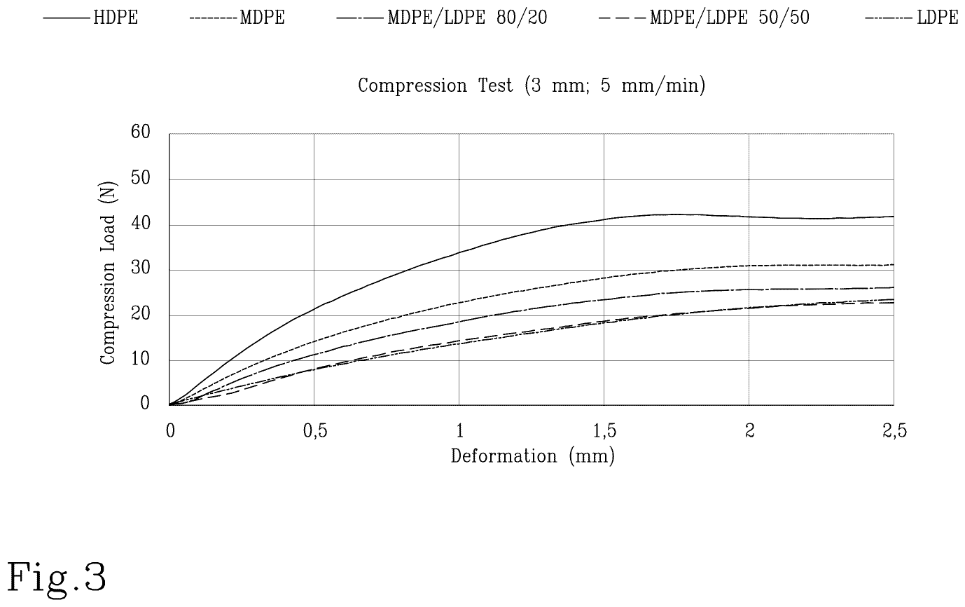

The HDPE cannot fulfil the requirements of application in squeezable bottles even in lightened bottles with a lower average thickness. Indeed, as shown in FIG. 2, the HDPE sample displays the yield point at very low deformation values below 2 mm and then the plastic behavior occurs. The neat MDPE sample does not show the yield point in the deformation range explored in this study and it likely happens at higher deformation values. The higher mechanical properties of MDPE compared to LDPE allow to decrease the weight by 25% and preserving mechanical properties of the bottle. The blend 80/20 shows a higher elastic modulus and compression load which means the higher application force to squeeze the bottle for the drug release. To reach a comparable mechanical behavior, the LDPE fraction has to be increased to 50% weight (blend 50/50). This blend provides very comparable values of both elastic modulus and compression load and even the stress/strain curve perfectly overlap the one of LDPE bottle with higher weight and thickness. These results prove the possibility to emulate the squeeze performance of LDPE adopting a more sustainable approach with a lightweight solution. FIG. 3 shows a stress/strain graph of compression test of bottles.

Similar results can be obtained using the HDPE instead of MDPE by increasing the LDPE fraction. It is worth to consider that the use of HDPE could lead to further product and process advantages. For example, thanks to the fast crystallization the lower blowing time and lower cycle time can be achieved. This aspect, along with the lightening of the bottle, reflects on a better sustainability of the product.

The possibility to emulate the mechanical properties of a squeezable bottle made of LDPE has been investigated. The challenge is addressed by a new design of the product with a lowered weight and thickness, from 0.92 mm to 0.75 mm, and replacing the LDPE with MDPE/LDPE blend. The mechanical characterization shows that the neat MDPE and HDPE cannot replace LDPE in lightened squeezable bottle due to their limited elastic range and excessive stiffness. Instead, the MDPE/LDPE blends display mechanical properties very close to the LDPE bottle. Specifically, the blend 50/50 emulate the same mechanical properties of the conventional squeezable bottle and it allows to decrease the bottle weight by 25%. It is worth to consider that the 25% lightweighting has a dual effect. First, it means plastic material saving and a more sustainable product on the shelf. Secondly, the lower thickness allows to reach a faster production process of the squeezable bottle with an economic benefit of the manufacturers.

1. A dropper container made by compression molding of a dose of molten polymeric material to obtain a preform and by successive blow molding of the preform, wherein the dropper container includes a body, the body being squeezable to dispense liquid contained therein and extending around a longitudinal axis between a first end and a second end, and a nozzle, connected to the body at the first end and configured for releasing liquid as droplets, responsive to a pressure of the liquid contained in the body, and wherein the polymeric material is a blend of LDPE and MDPE, the LDPE being at least 20% of the total weight of the polymeric material.

2. The dropper container according to claim 1, wherein the LDPE is at least 50% of the total weight of the polymeric material.

3. The dropper container according to claim 1, wherein the LDPE is lower than 85% of the total weight of the polymeric material.

4. The dropper container according to claim 3, wherein the LDPE is lower than 60% of the total weight of the polymeric material.

5. The dropper container according to claim 1, wherein the body has a wall having an average thickness comprised between 0.5 mm and 0.85 mm.

6. The dropper container according to claim 1, wherein the body has a wall having an average thickness comprised between 0.7 mm and 0.8 mm.

7. The dropper container according to claim 1, having a capacity in the range 5-15 ml, wherein the ratio between a volumetric capacity and a weight of the body is higher than 3.0 ml/g.

8. The dropper container according to claim 1, wherein the die swell of the polymeric material is higher than 1.3.

9. Use of a polymeric material for making a dropper container, the dropper container being made by compression molding of a dose of molten polymeric material to obtain a preform and by successive blow molding of the preform, wherein the dropper container includes a body, squeezable to dispense liquid contained therein and extending around a longitudinal axis between a first end and a second end, and a nozzle, connected to the body at the first end and configured for releasing liquid as droplets, responsive to a pressure of the liquid contained in the body, and wherein the polymeric material is a blend of LDPE and MDPE, the LDPE being at least 20% of the total weight of the polymeric material.

10. The use of the polymeric material according to claim 9, wherein the LDPE is at least 50% of the total weight of the polymeric material.

11. The use of the polymeric material according to claim 9, wherein the LDPE is lower than 85% of the total weight of the polymeric material.

12. The use of the polymeric material according to claim 11, wherein the LDPE is lower than 60% of the total weight of the polymeric material.

13. The use of polymeric material according to claim 9, wherein the die swell of the polymeric material is higher than 1.3.

14. A method for making a dropper container, the dropper container including a body, the body being squeezable to dispense liquid contained therein and extending around a longitudinal axis between a first end and a second end, and a nozzle, connected to the body at the first end and configured for releasing liquid as droplets, responsive to a pressure of the liquid contained in the body, the method comprising the following steps:
compression molding of a dose of molten polymeric material to obtain a preform;
blow molding of the preform to obtain the dropper container,
wherein the polymeric material is a blend of LDPE and MDPE, the LDPE being at least 20% of the total weight of the polymeric material.

15. The method according to claim 14, wherein the LDPE is at least 50% of the total weight of the polymeric material.

16. The method according to claim 14, wherein the LDPE is lower than 85% of the total weight of the polymeric material.

17. The method according to claim 16, wherein the LDPE is lower than 60% of the total weight of the polymeric material.

18. The method according to claim 14, wherein the body has a wall having an average thickness comprised between 0.5 mm and 0.85 mm.

19. The method according to claim 14, wherein the dropper container has a capacity of 5 mL and a weight of the body without the liquid is lower than 1.5 g.

20. The method according to claim 14, wherein the die swell of the polymeric material is higher than 1.3.
